(19) United States
(12) Patent Application Publication
(10) Pub. No.: US 2007/0294142 A1
(43) Pub. Date: Dec. 20, 2007

(54) SYSTEMS AND METHODS TO TRY ON, COMPARE, SELECT AND BUY APPAREL

(76) Inventor: Ping Liu Kattner, Bloomington, IN (US)

Correspondence Address: Ping Liu Kattner, 632 Ridge Crest CT, Bloomington, IN, 47401, US

(21) Appl. No.: 11/754,508

(22) Filed: May 29, 2007

Related U.S. Application Data
(60) Provisional application No. 60/805,229, filed on Jun. 20, 2006.
(60) Provisional application No. 60/869,311, filed on Dec. 8, 2006.

(51) Int. Cl. G06Q 30/00

(52) U.S. Cl. 705/27; 715/810

(57) ABSTRACT

This invention provides methods and systems for a user to try on, compare, select and buy apparel (including hairstyles and lipsticks) in a computer based environment. By using a picture of the user or anyone else, the system creates a realistic model of the person. Then the user can put different apparel items on the model. Different categories of apparel items (for example, a top and a skirt) can be put on the model at the same time. Several images of the model wearing different items can simultaneously display. The user can also try apparel items from the Internet on the model. When the user likes an item, a link can lead the user go to online stores that sell related items.

### RELATED APPLICATION DATA

This application claims priority to the following provisional patent applications:
Appl. No. 60/805,229, filed Jun. 20, 2006;
Appl. No. 60/869,311, filed Dec. 8, 2006.

### BACKGROUND OF THE INVENTION

Most people feel a sense of difficulty and indecisiveness when confronted with the task of deciding upon some new clothes, lipstick, a handbag, a pair of shoes to buy, or which new hairstyle to try out. When a person needs to dress up, that person often has no ideas about what to wear and is often asking themselves questions such as “What color of top matches what color of skirt better?”, “What kind of a hairstyle matches what kind of a dress better?”, and “How can I make my self more attractive?” These are personal preference problems that people meet every day when thinking about their appearance and certainly everyone would like to have answers to.

As people more and more accept the Internet, shopping on the Internet becomes more popular at present. But shopping online is much different from shopping in traditional stores. People usually couldn't touch or try items as they do in traditional stores. For example, when a person wants to buy a shirt in a traditional store, the person can try on the shirt in a dressing room to see if that shirt is good enough, and thereby to make a decision as to buy or not to buy. However, if the person wants to buy a shirt online, the person cannot see herself or himself wearing the shirt. This becomes a huge limitation for people to shopping online.

Presently one can find websites and makeover systems that provide users with the ability to manipulate the appearance of a virtual image. Unfortunately most of them only allow a user to modify the image from the shoulder up, for example, by changing articles such as eyeglasses, jewelry, hats, etc., or by changing hairstyles. These websites and makeover systems don't provide the tools needed that would allow users to place articles like tops, pants, shoes, skirts, etc. on their virtual image.

One can also find websites and makeover systems may do provide their users with the ability to place tops, pants, etc on their virtual models. But they don't offer the ability to simultaneously display several images of the virtual model, with each image wearing different clothes, so that the user can easily see how different apparel items compare and contrast. They may not display an overall appearance of a person by putting a top, a pair of pants, a hairstyle, a pair of shoes, etc., on an image all at one time. These types of systems may also have the following shortcomings:
i. The image used to place articles on may not appear realistic or may not look like the user.
ii. It ma y be quite difficult to produce an image that does look like the user.
iii. If a system does use a full picture (from head to foot) of a real person upon which to place articles of apparel, a user may need to supply a naked picture of the person. This seems impractical. To look natural, the articles to be put on the picture need to be resized and transformed in order to fit properly. Owing to the fact that everyone's body shape is different, and the pose of the person in a picture may vary quite a bit from one photograph to another, even a professional graphic artist will find it difficult to fit an article properly on the picture.

### BRIEF SUMMARY OF THE INVENTION

This invention provides two computer-based systems. They can operate separately. In one system, the part of the software for a user to try on apparel is a client-side program which mainly resides on the user's computer. Hereinafter this system will be referred to as system 1. Another system is for a user trying on apparel directly on a website through an Internet browser. Hereinafter this system will be referred to as system 2. Further description of the systems will be provided in the section of “detailed description of the invention”.

By using a picture of a person, a realistic model (with head and body) of the person is created. Apparel items (including hairstyles and lipsticks) can then be put on the model.

In one aspect, the invention provides a method in a computer system for creating a digital model of a person based on a picture of the person. The method includes displaying a picture representing the image of a person; getting a head portion of the picture which this portion is outlined by an adjustable curve showing around the head; resizing a standard body image according to a body shape parameter selected by the user, which the standard body image is an image previously stored in the computer system; colorizing the body by using a sampled skin color from the head portion; merging the resized body and the head portion together.

In another aspect, the invention is a method in a computer system for allowing a user to compare and select apparel. The method includes simultaneously displaying several images of a model with each image dressed differently, each image is a composite image generated in the system by merging the model and apparel items together, and the model represents the image of a person. The method also includes displaying a composite image of a model wearing simultaneously several items of apparel from a variety of different categories, and the model represents the image (includes head and body) of a person (could be the user); steps includes iteratively accepting a selection of an apparel item in a category (e.g. pants), or a selection of a hairstyle or a lipstick; calculating the position of the select item in an array of the model according to daily life, the array storing the data of all the items being put on the model; inserting a new item or updating an old item in the array at the calculated position with the selected item; displaying a composite image by merging the model and all the items in the array together.

Still in another aspect, the invention is a method in a computer system for allowing a user to try on apparel from the Internet, which the part of the software for the user to try on apparel mainly resides on the user's computer. The method includes displaying an image of the created model wearing apparel items that selected by the user on a website. The method also includes simultaneously displaying several images of a model with each image wearing different apparel items selected by the user on a website.

Still in another aspect, the invention is a method for allowing a user to try on apparel from the Internet directly on a website. The method includes displaying on a web page an image of the created model wearing apparel items selected by the user on a website. The method also includes displaying on a web page a composite image of the model wearing simultaneously several apparel items chosen by the user.

Still in another aspect, the invention is a method for allowing a user to buy apparel online. Steps of the method includes trying on apparel on a digital model of a person; when the user selects an apparel item to shop, directly connecting to an online store or a website selling related items; or displaying information about online stores or websites that have information related to the item, and connecting to the online store or website when the user selects one. After the user connect to an online store or website, the user then can shop there.

In still another aspect, the invention provides a method for allowing a user to take off apparel items being put on a model.

Further, the invention is a method in a computer system for allowing a user to edit an apparel item. This includes accepting a selection of an apparel item in a category; displaying an image of the selected item for editing; accepting selection of an editing area on the item; iteratively accepting a selection chosen by the user, the selection could be a color, a type of texture, or a pattern; displaying the item modified with the editing area in the selected color, texture, and pattern, according to the selections chosen for the editing area by the user.

Further more, this invention provides a computer program including source codes and data as a tool that allows a user to try on, compare, select and buy apparel.

Still further more, this invention provides a user-interface on a computer for allowing a user to try on, compare, select and buy apparel. The user-interface includes an interface for the user to create a digital model of a person based on a picture of the person; an interface for the user to try on, compare and select apparel; an interface for the user to edit apparel.

### BRIEF DESCRIPTION OF THE DRAWINGS

FIG. 1 is an illustration of a structure in accordance with an example of system 1 in the invention.

FIG. 2 is an illustration of a first screen in accordance with an example of system 1 in the invention.

FIG. 3 is an illustration of a second screen in accordance with an example of system 1 in the invention.

FIG. 4 is an illustration of a third screen in accordance with an example of system 1 in the invention.

FIG. 5 is an illustration of a fourth screen in accordance with an example of system 1 in the invention.

FIG. 6 is an illustration of a fifth screen in accordance with an example of system 1 in the invention.

FIG. 7 is an illustration of a sixth screen in accordance with an example of system 1 in the invention.

FIG. 8 is an illustration of a structure in accordance with an example of system 2 in the invention.

FIG. 9 is an illustration of a main screen in accordance with an example of system 2 in the invention.

### DETAILED DESCRIPTION OF THE INVENTION

We know that apparel plays an important role in people's appearance. But what to buy and what to wear are always problems that puzzle people. A motivation for this invention is to expand people's experience with apparel, and to provide an easy and practical way to help them make decisions about what to buy and what to wear.

Another motivation for this invention is how to help people to do their online shopping.

The following considerations can be found in the invention.
i. One problem was how to create a model of a person based on a picture of the person, so that the model looks like the natural person, and it should not be too difficulty to achieve an ideal result. The invention provides a solution for this problem. From a picture of a person that shows the full face and neck, the system then uses the head portion from the picture along with a standard body image (this could be male, female, etc. according to the person) that is stored in the system. Then the standard body image is resized according to a body shape parameter selected by the user. Next color is added to the body. The color is determined using skin color samples from the head portion. The system then merges the head, which is outlined by an adjustable curve around the head, and body to create the model. In order to look natural at the joint line of the head and the body, the system allows the body and head to have a small overlapping area, and the color of the overlapping area gradually changes from that of the body to that of the head.
ii. How to let a user to compare and select apparel items very easily and intuitively? A solution for solving the problem is provided in the invention. The system lets the user choose what to compare, for example to compare items of different styles in a category of apparel with the same color, or to compare items with the same style but different colors in a color group. Then the system organizes items of apparel in different pages. Then the system displays one page after another either manually or automatically. Each page comprises of several images of the model to simultaneously display, and each image is a composite image of the model wearing different items of apparel. The number and size of images to simultaneously display can be changed, and the background color to display can be changed too. Because several images of the model wearing different clothes are simultaneously displayed on a computer screen, it is very easy and intuitively for the user to compare and select.
iii. How to put several items in different categories of apparel on the model, and display a composite image of the model with all the items together? A solution for this problem is provided in the invention. The system defines a data structure “layer”. A layer is used to store the data of an item being put on the model. The model could have many layers. Layers are arranged in an array. Whenever a new item of apparel is put on the model, according to daily life, the system calculates what position of the new item should be in the layer array, and then insert a new layer or update an old layer in the layer array with the data of the new item. For example, in daily life, two jackets usually don't wear together, and a top usually wouldn't be put over a jacket. When the system display the model with all items being put on, the system gets the data of items in the lay array, and merge all the items into a whole apparel image, and the apparel image is merged with the model into a composite image of the model.
iv. In reality the diversity of apparel could be unlimited. How to provide the user flexibility to modify an item? A solution for this problem is provided in the invention. The system defines a data structure “trace”. A trace is used to store an outline of area on an apparel item, which the area could be the whole item or part of the item. An item could have many traces. A trace has properties like color, texture, and pattern. The user can change a trace's properties. Millions of colors can be selected for a trace. The system uses all the traces and their properties of an item to create a new apparel item. This will provide unlimited experience for the user.
v. As the Internet becomes widely accepted by people, many people will do their shopping online. How to help people to do their online shopping? In the invention, a website is provided. The data of apparel items can be stored on the website. Apparel items on the website are dynamic changeable. They can be up to date apparel products sent by or selected from online stores or designers. The user can try on items from the website. A merchant can put links to items that a user can try on. If the user likes an item, the user can choose to shop for the item. The user will be linked to merchant's website selling related items. Then the user can shop at the merchant's website.

As mentioned above, this invention provides two systems: system 1 and system 2. Both systems use the same method to create a digital model of a person, the same data of apparel items stored on a website, and the same method to link to a merchant's website. If possible, we will only describe these common methods in system 1 and don't reiterate in system 2. The following sections describe system 1 and system 2 separately.

1. System 1

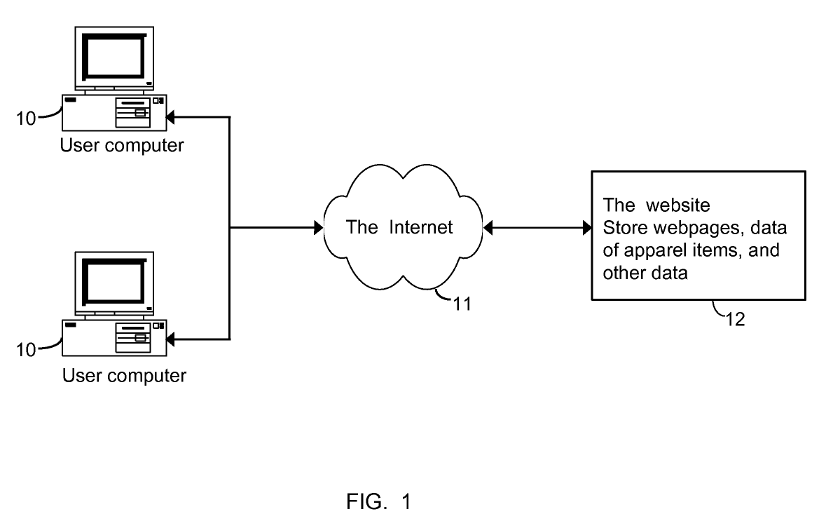

FIG. 1 shows an example of the structure of system 1. A user installs the software of system 1 on the user's computer 10. Through the Internet 11, the user can try on apparel items from the website 12. If the user's computer doesn't connect to the Internet 11, the user can only try on apparel items previously packed in the software of system 1 and stored on the user's computer 10.

In order to let a user try on apparel items, first need to prepare apparel data. The system uses two types of apparel data: changeable apparel items and non-changeable apparel items. A changeable apparel item is an item that its color, texture and pattern can be changed by the user. A non-changeable apparel item can not be edited by the user, which it is usually an apparel product. No matter changeable or non-changeable, an apparel item in the system is prepared in such a way that it is suitable to wear on a standard model which the model's body is used to create a digital model of a person. The data of prepared apparel items are either previously packed in the software of system 1, or dynamically stored on the website 12. When the user tries on an apparel item on the created digital model, the prepared apparel item will be reshaped to be suitable to wear on the created model.

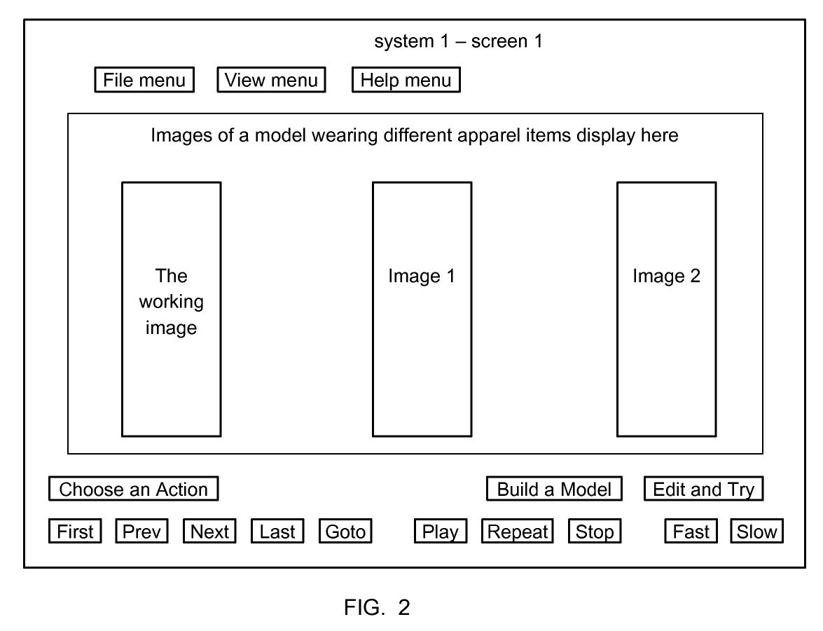

After the user runs system 1, the system displays exemplary screen 1 shown in FIG. 2 on the user's computer screen. Screen 1 includes menu and button options available to the user. Exemplary menu options include “File menu”, “View menu”, “Help menu”. Exemplary button options include “Choose an Action”, “Build a Model”, “Edit and Try”, “First”, “Next”, “Prev”, “Last”, “Goto”, “Play”, “Repeat”, “Stop”, “Fast”, and “Slow”.

“File menu” further includes exemplary options of “File/Load”, “File/Save”, “File/Load Sample/Female”, “File/Load Sample/Male”, and “File/Exit”. “View menu” further includes exemplary options of “View/Apparel Online”, “View/Background Color”, “View/Model Numbers”, and “View/Default”. “Help menu” further includes exemplary options of “Help/Contents” and “Help/About Us”.

Because many options need a model to become available, the user may choose “Build a Model” to create a new model, or choose “File/Load Sample” to load a sample model the system provides, or choose “File/Load” to load a previous saved model by the user. If the user chooses to load a sample model or previous saved model, the image of a sample or previous saved model will be displayed on the left side of screen 1. This image in the system is called the working image as shown in FIG. 2.

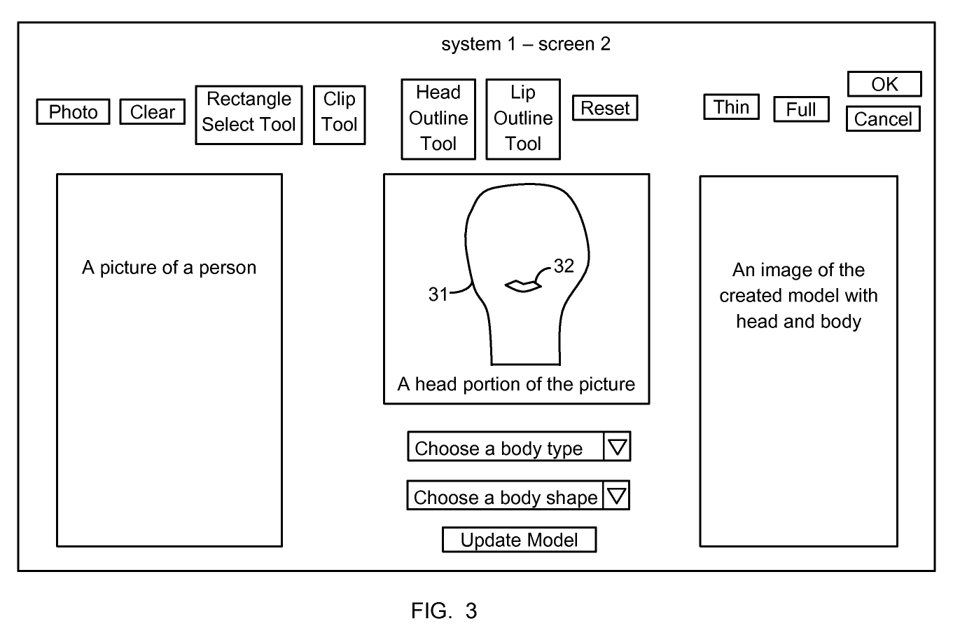

If the user chooses “Build a Model” to create a new model, the system will display exemplary screen 2 shown in FIG. 3. Screen 2 includes button and dropdown list options for the user to choose. Exemplary button options on screen 2 include “Photo”, “Clear”, “Rectangle Select Tool”, “Clip Tool”, “Head Outline Tool”, “Lip Outline Tool”, “Reset”, “Update Model”, “Thin”, “Full”, “OK”, and “Cancel”. Exemplary dropdown list options on screen 2 include “Choose a body type” and “Choose a body shape”. “Cancel” option is used to quit screen 2 without creating a model. “Photo” option is used to load a digital image of a person into the system. The digital image could be taken using a digital camera and be stored on the computer, or be scanned using a scanner from a photo taken by an optical camera and be stored on the computer. The person in the image could be the user or anyone else. After the user chose “Photo” option, the system loads in the digital image, and the image is displayed on the left side of screen 2. “Clear” option allows the user to clear the loaded image. “Rectangle Select Tool” option is used to let the user to select a rectangle area around the head (include face and neck) of the image. After a rectangle area is selected, the user chooses “Clip Tool” option to clip the area. Then a resized rectangle head portion of the image is displayed on the center of screen 2. Two curves are displayed on the head image, one around the head called head outline 31, and the other around the lips called lip outline 32. Head outline 31 is used to outline the head, and only the area inside the outline is used to merge with the standard body to create a model. Lip outline 32 is used to outline the lips, so that lipsticks could be added on the lips late. The user can edit a curve by move the whole curve or move a control point on the curve. “Head Outline Tool” option is used to edit head outline 31. “Lip Outline Tool” option is used to edit lip outline 32. “Reset” option allows the user to clear the changes added to the curves. “Choose a body type” and “Choose a body shape” options are used to let the user select a body type and a body shape. An exemplary body type could be woman, man, etc. An exemplary body shape could be middle, thin, full, etc. After a body type and body shape was selected, the user chooses “Update Model” button to create a new model. Then an image of the model is displayed on the right side of screen 2. The user can further adjust the body shape of the model by choosing “Thin” and “Full” options. Finally the user chooses “OK” option on screen 2, and then the image of the newly created model will be displayed on the left side of screen 1, as the working image.

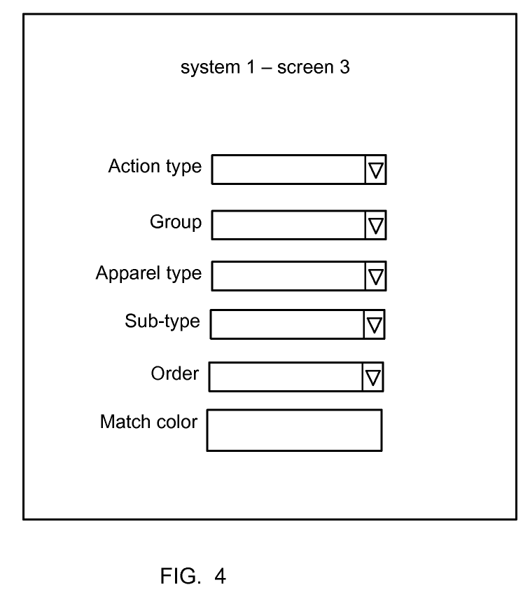

Now back on screen 1. With the working image on screen 1, the user can choose the “Choose an Action” button. Then the system displays exemplary screen 3 shown in FIG. 4. Screen 3 includes dropdown list options for the user to choose. Exemplary options available to the user include dropdown lists “Action type”, “Group”, “Apparel type”, “Sub-type”, “Order”, and a color selection patch “Match color”. “Action type” option defines what to do for the action. It includes a list of actions for the user to choose. An exemplary list includes “Choose Styles”, “Choose Colors”, and “Choose Lipsticks”. If the action type is “Choose Styles”, apparel items in a category with different styles but the same color will be put on the model, the color is defined by choosing “Match color” option. If the action type is “Choose Colors”, apparel items with different colors in a color group but the same style will be put on the model. If the action type is “Choose Lipsticks”, different colors of lipstick in a color group will be put on the model. “Group” option defines color groups when the action type is “Choose Colors”, or “Choose Lipsticks”. It includes a list for the user to choose. A color group includes many different colors. An exemplary color group is “Sharp Colors”. Colors in this group are contrast sharply to a match color. For example, if a match color is red, colors in the sharp color group may be green or blue. This is very useful when people want to match an apparel item. “Apparel type” option defines the category of apparel to compare if the action type is “Choose Styles”. If the action type is “Choose Colors”, “Apparel type” defines which item to change colors; this item is previously put on the model. “Sub-type” option is a subset of category of apparel. For example, if an apparel type is “top”, a sub-type could be “sleeveless top”. “Order” option defines the sequence of apparel items to display. An exemplary order is “By Hue” when the action type is “Choose Colors”. If the order option is “By Hue”, apparel items with colors in similar hue will display consecutive. “Match color” option defines a color to match if the action type is “Choose Colors” or “Choose Lipsticks”. When the user chooses “Match color”, a true color palette display, the user can select a color on the color palette among millions of colors.

Upon the user finish choosing the options on screen 3 (an action), several images of the model, each image wearing a different apparel item in the action, are displayed on screen 1 simultaneously. All the apparel items in the action are arranged in different pages. Now on screen 1, the user can manually browse a page by choosing “First”, “Next”, “Prev”, “Last”, and “Goto” options. The user can automatically browse all the pages by choosing “Play”, “Repeat”, and “Stop” options. “Fast” and “Slow” options are used to control the speed to automatically display the pages. If the user found a preferred apparel item, the user can select on the image wearing the item, and then the item is put on the working image. If the working image has other apparel items being put on before, the new one will be merged with the old ones and the model, by either replace an old item or add a new item, and form a composite image of the model.

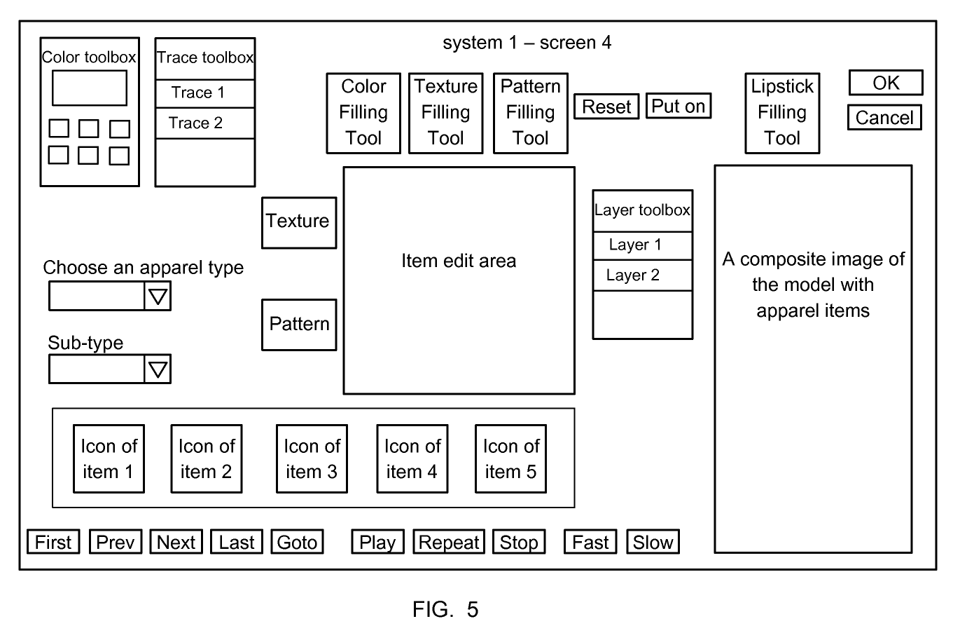

On screen 1, the user can select the number of images to simultaneously display by choosing “View/Model Numbers”. The user can also change the background color of screen 1 by choosing “View/Background Color”. A background color is useful to simulate a reality environment, as the same color usually looks different under different environments. The size of the screen can be changed too. These options allow the user to compare and select apparel more convenient. The user can choose “File/Save” to save the model, so the user can use the model next time. If the user choose “Edit and Try” button, the system will display screen 4 shown in FIG. 5.

On screen 4, the user can edit and try on an apparel item. Screen 4 includes button, dropdown list, and toolbox options for the user to choose. Exemplary dropdown list options include “Choose an apparel type” and “Sub-type”. Exemplary button options include “Texture”, “Pattern”, “Color Filling Tool”, “Texture Filling Tool”, “Pattern Filling Tool”, “Lipstick Filling Tool”, “Reset”, “Put on”, “First”, “Next”, “Prev”, “Last”, “Goto”, “Play”, “Repeat”, “Stop”, “Fast”, “Slow”, “OK”, and “Cancel”. Exemplary toolbox options include “Color toolbox”, “Trace toolbox”, and “Layer toolbox”. “Cancel” option is used to quit screen 4 without making change. “Choose an apparel type” option allows the user to choose a category of apparel. “Sub-type” option allows the user to choose a sub category of apparel. After the user chose an apparel type and a sub type (e.g. an apparel type is top, a sub type is sleeveless top), the system displays several small images of apparel items in the chosen category at the left bottom of the screen, called “icon of item 1”, “icon of item 2” etc. as shown in FIG. 5. The apparel items in the chosen category are arranged in pages according to how many icons to display each time. If there are many pages of items, the user can manually browse a page by choosing “First”, “Next”, “Prev”, “Last”, and “Goto” button. The user can also automatically browse all the pages by choosing “Play”, “Repeat”, and “Stop” options. If the user found the item to edit, the user can select on the icon of the item, and then a resized image of the item will be displayed in the center of the screen in the “item edit area”. Steps for the user to give a color to the item include: selecting a color in the “Color toolbox“; selecting a trace in the “Trace toolbox”; choosing “Color Filling Tool” button; filling the color on the item in the “item edit area”. Steps for the user to give a texture to the item include: choosing “Texture” button, then the system will display a screen with many texture images allowing the user to select, and selecting a texture; selecting a trace in the “Trace toolbox”; selecting “Texture Filling Tool” button; filling the texture on the item in the “item edit area”. Steps for the user to give a pattern to the item are similar to give a texture. Upon the user's choices, a new image of the item with the selected color, texture, and pattern being displayed in the “item edit area”. “Reset” option allows the user to clear all the changes added on the item. “Put on” option allows the user to put the item in the “item edit area” on the model. “Layer toolbox” is used to indicate the layer array of the model (refers to above for the explanation of layer and layer array). If the user choose “Put on”, the item in the “item edit area”, which may with changes made by the user, is stored in the layer array of the model, and on the right side of screen 4 the system displays a composite image of the model wearing the item in the “item edit area” merged with the other items being previously put on the model. “Lipstick Filling Tool” is used to allow the user to apply a lipstick on the model. If the user chooses “OK”, the composite image of the model will be displayed on the left side of screen 1, as the working image.

On screen 1, on the working image, the system provides options for the user to choose. An exemplary option is “Print”. “Print” option allows the user to print the working image in a printer.

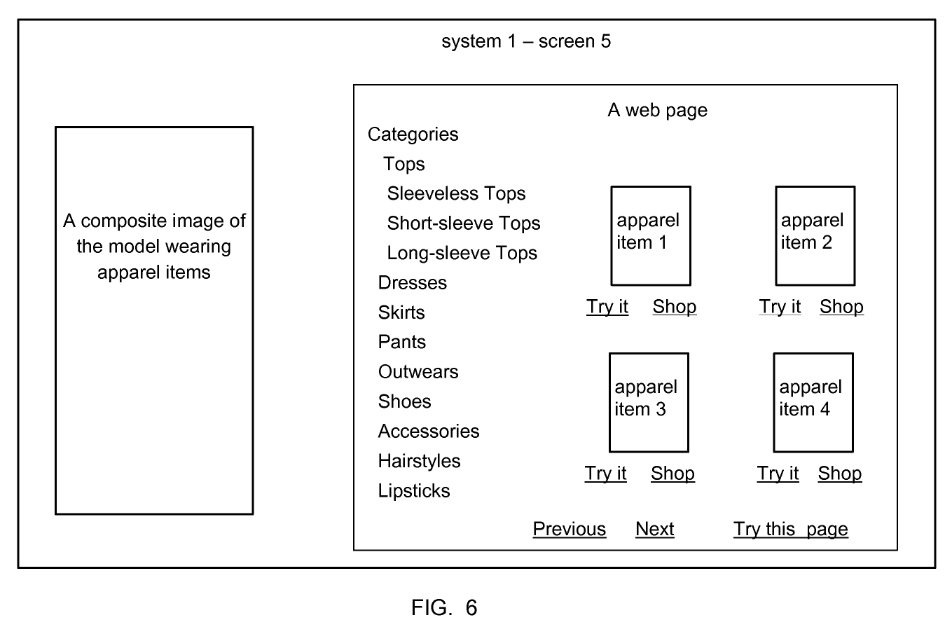

On screen 1, the user can choose “View/Apparel Online” to try on apparel items from the Internet. When the user chooses “View/Apparel Online” option, the system displays an exemplary screen 5 in FIG. 6.

Screen 5 includes a web page which comes from the website 12. The web page includes options for the user to choose. Exemplary options are “Try it”, “Try this page”, “Previous”, “Next”, “Shop”, and “Categories” of apparel. Exemplary “Categories” may include “Tops”, “Dresses”, “Pants”, “Skirts”, “Outwear”, “Accessories”, “Hairstyles”, “Lipsticks”, etc. When the user chooses a category of apparel on the web page of screen 5, the system displays images of apparel items under this category, called “apparel item 1”, “apparel item 2”, etc. “Previous” or “Next” are used for browsing the previous or the next page of apparel items under a chosen category. If the user chooses “Try it” by an apparel item, the system checks if there is a working image (a model) on screen 1. If there is a model, the system displays an image at the working image of screen 1 showing the model wearing the apparel item chosen by the user. The user can choose apparel items under different categories on the web page of screen 5. The system displays an image of the model wearing several different apparel items at the same time. Similarly, if the user chooses “Try this page”, the system checks if there is a model. If there is a model, the system simultaneously displays several images of the model on screen 1, with each image wearing different apparel items from the web page. If the user chooses “Shop” by an apparel item on screen 5, the system displays a web page of a merchant's website, or displays a web page with links to merchants' websites.

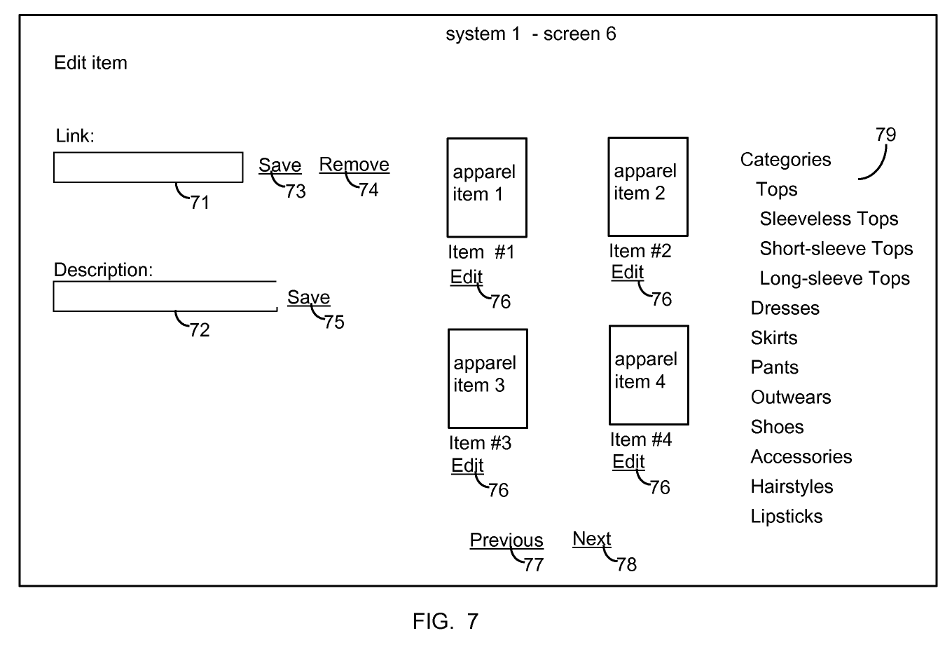

Screen 6 in FIG. 7 shows how merchants can link to their websites so that they can sell their products. On the website 12, a merchant log in so that the web page of screen 6 becomes available. On screen 6, the merchant can add links to apparel items. After a link being added to an item, the link will become available on screen 5 when the user shops for the item. On screen 6, the system provides options for the user to choose. Exemplary options are text box 71, text box 72, “Save” 73, “Remove” 74, “Save” 75, “Edit” 76, “Previous” 77, “Next” 78, “Categories” 79. Exemplary “Categories” 79 may includes “Tops”, “Dresses”, “Pants”, “Skirts”, “Outwear”, “Accessories”, “Hairstyles”, “Lipsticks”, etc. When the merchant chooses a category on screen 6, the system displays images of apparel items under this category. “Previous” 77 or “Next” 78 are used for browsing the previous or the next page of apparel items under a chosen category. The merchant can choose “Edit” 76 by an item to edit a link to the item. The previous link (if any) and previous description (if any), of the item, will respectively display in text box 71 and text box 72. The content of text box 71 is a link to a web page of the merchant's website. The content of text box 72 is a description to the link (used as a catch phrase). The user can add or change contents in text box 71 and text box 72. “Save” 73 stores the content in text box 71 on the website 12. “Save” 75 stores the content in text box 72 on the website 12. “Remove” 74 removes the previous stored link from the website 12.

2. System 2

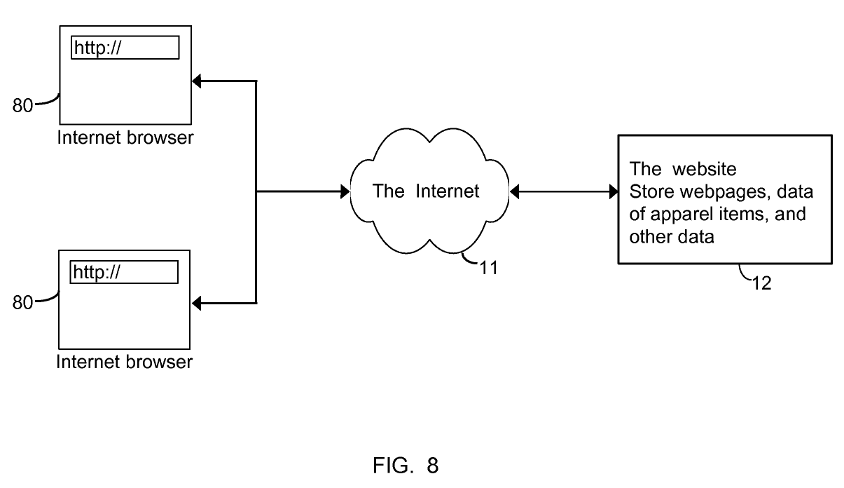

FIG. 8 shows an example of the structure of system 2. In system 2, through the Internet 11, a user tries on apparel items from the website 12 in an Internet browser 80 on the user's computer.

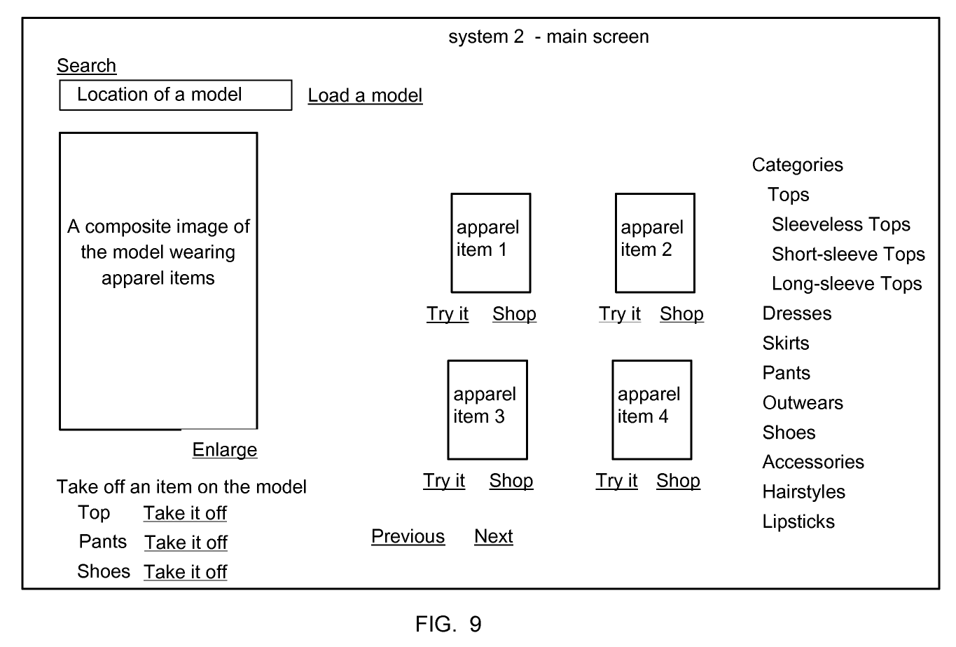

The user enters a web address of the website 12 in an Internet browser 80 on the user's computer. The Internet browser 80 displays a web page of the website 12. There is a choice on the web page for the user to try on apparel. After the user chooses to do so, the system displays an exemplary main screen of system 2 in FIG. 9.

There are many options on the main screen available to the user. Exemplary options include “Search”, “Load a model”, “Try it”, “Previous”, “Next”, “Shop”, “Take it off”, “Enlarge”, and “Categories” of apparel. Exemplary “Categories” may include “Tops”, “Dresses”, “Pants”, “Skirts”, “Outwear”, “Accessories”, “Hairstyles”, “Lipsticks”, etc. When the user chooses a category of apparel, the system displays images of apparel items under this category, called “apparel item 1”, “apparel item 2”, etc. “Previous” or “Next” are used for browsing the previous or the next page of apparel items under a chosen category.

In order to try on apparel, the system needs load in a digital model. As mentioned before, a digital model is created in the same way as in system 1, and is stored in a file either on the user's computer or on the website 12. On the main screen, the user chooses “Search” to find the location where the model file stored. Then the user chooses “Load a model”. Then the system displays an image of the model on the left side of the main screen. If the user chooses “Try it” by an apparel item, the system checks if there is a model. If there is a model, the system displays an image of the model wearing the apparel item chosen by the user, and the apparel item's name (usually a category name) being listed under the “Take off an item on the model” area. The user can choose apparel items under different categories to wear on the model at the same time. If the user chooses “Take it off” by an apparel item being put on the model, the system displays an image of the model with the apparel item being taken off. If the user chooses “Enlarge”, the system displays an enlarged image of the model wearing apparel items being put on. If the user chooses “Shop” by an apparel item, the system displays a web page of a merchant's website, or displays a web page with links to merchants' websites.

The invention claimed is:

1. A method provided by a computer tool that allows a user to try on apparel, the method comprising:
displaying a picture representing the image of a person;
displaying a head portion of the picture which this portion is outlined by an adjustable curve showing around the head;
resizing a standard body image according to a body shape parameter selected by the user, which the standard body image is previously stored in a computer;
colorizing the resized body by using a sampled skin color from the head portion;
merging the resized body and the head portion together to create a digital model of the person;
displaying an image of the digital model wearing apparel items selected by the user.

2. The method of claim 1, wherein the digital model, including head and body, is an image of the user.

3. The method of claim 1, wherein the apparel items are selected from categories consisting of clothes (include but not limited to tops, bottoms, dresses, shoes, accessories), hairstyles, lipsticks, and combinations thereof.

4. The method of claim 1, further comprising reshaping the apparel items selected by the user to be suitable to put on the digital model.

5. The method of claim 1, further comprising editing an apparel item by given the item different colors, patterns, textures, and combinations thereof.

6. The method of claim 1, wherein the apparel items come from the Internet by stored on a website.

7. The method of claim 1, further comprising storing the digital model on a website.

8. The method of claim 1, further comprising storing the digital model on the user's computer.

9. The method of claim 1, further comprising taking off apparel items being previously put on the digital model.

10. A method provided by a computer tool that allows a user to compare apparel, the method comprising simultaneously displaying more than one images of a digital model of a person, with each image wearing different apparel items, in which at least one image is a composite image generated in a computer by merging the model and the apparel items selected by the user.

11. The method of claim 10, wherein the apparel items are selected from the group consisting of clothes (include but not limited to tops, bottoms, dresses, shoes, accessories), hairstyles, lipsticks, and combinations thereof.

12. The method of claim 10, wherein the digital model is an image of the user.

13. A method provided by a computer tool for a user to try on and buy apparel, the method comprising:
displaying an image of a digital model of a person wearing apparel items selected by the user;
directly linking the user to an online store or a website selling related items when the user chooses shopping an item;
or displaying information about online stores or websites that have information related to the item;
and linking the user to the online store or website when the user selects one.

14. The method of claim 13, wherein the digital model is an image of the user.

15. The method of claim 13, wherein the apparel items are selected from the group consisting of clothes (include but not limited to tops, bottoms, dresses, shoes, accessories), hairstyles, lipsticks, and combinations thereof.

16. The method of claim 13, further comprising the steps of enabling merchants to sell their products:
accepting apparel images provided by or selected from a merchant;
processing the apparel images to be suitable to put on the digital model;
storing and posting the processed apparel items on a website;
linking the posted items to the merchant's web pages.
